(19) United States
(12) Patent Application Publication
(10) Pub. No.: US 2006/0043958 A1
(43) Pub. Date: Mar. 2, 2006

(54) Beam current measurement

(75) Inventors: Hubertus Maria Rene Cortenraad, Eindhoven (DE); Theodoru Johannes Petrus Van Den Biggelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/527,895

(22) PCT Filed: Aug. 8, 2003
(86) PCT No.: PCT/IB03/03623

§ 371 Date: Mar. 15, 2005

(30) Foreign Application Priority Data
Sep. 18, 2002 (EP) 02078865.9

(51) Int. Cl. G01N 27/00

(52) U.S. Cl. 324/71.3

(57) ABSTRACT

The display apparatus comprises a picture tube (CRT) with an electron gun which generates an electron beam (BB) directed towards a display screen. The electron gun comprises a first and a second electrode (CA, G1). The electron beam (EB) originates from the first electrode (CA). The voltage between the first electrode (CA) and the second electrode ( G1) controls the intensity of the electron beam (EB). A beam current (IB) flows in the first electrode (CA) in response to the electron beam (EB). A [symbol] (ICA) in the first electrode (CA) is the sum of the beam current (IB) and a current (IC) flowing through a capacitance (CWN) between the first and the second electrode (CA, G1). A compensation circuit (COM) supplies a compensation current (ICO) to the first electrode (CA) to compensate for a capacitive current (IC) through a capacitance (CIN) between the first and the second electrode (CA, G1). A beam current measurement circuit (BMC) measures the total current (IT) which is the sum of the total current in the first electrode (ICA) and the compensation current (ICO).

The invention relates to a display apparatus, a beam current measurement circuit, and a method of measuring a beam current.

EP-A-0750390 discloses a kinescope driver apparatus in which a complementary push-pull emitter follower amplifier is coupled between the output of a high voltage driver amplifier and the cathode of a kinescope cathode for reducing the effective load capacitance presented to the driver amplifier. An automatic kinescope bias (AKB) sensing circuit senses the cathode current to generate an AKB output signal proportional to the cathode current. The AKB sensing circuit senses the cathode current near to the cutoff of the cathode.

It is an object of the invention to provide a beam current sensing circuit which is able to measure the beam current more accurately.

A first aspect of the invention provides a display apparatus as claimed in claim 1. A second aspect of the invention provides a beam current measurement circuit as claimed in claim 9. A third aspect of the invention provides a method of measuring a beam current in a display apparatus as claimed in claim 10. Advantageous embodiments are defined in the dependent claims.

The display apparatus comprises a picture tube (called kinescope in the prior art) with an electron gun which generates an electron beam directed towards a display screen. The electron gun comprises a first and a second electrode. The electron beam originates from the first electrode. The voltage between the first electrode and the second electrode controls the intensity of the electron beam. A beam current flows in the first electrode in response to the electron beam.

A compensation circuit supplies a compensation current to the first electrode to compensate for a capacitive current through a capacitance between the first and the second electrode. A beam current measurement circuit measures the total current which is the addition of the beam current, a capacitive current between the first and the second electrode, and the compensation current.

A drive circuit supplies a drive signal to the first electrode or the second electrode only, or to both electrodes to obtain the voltage between the electrodes of the electron gun to modulate the intensity of the electron beam. A beam current measurement circuit measures the beam current flowing in the first electrode in response to the electron beam.

Usually, in electron guns, the first electrode is the cathode and the second electrode is the G1-grid. The amount of electrons produced depends to a large extent on the drive voltage applied between the cathode and the G1-grid only. Therefore, the intensity of the electron beam can be modulated by supplying the drive voltage either between the cathode and the G1-grid, or to the cathode only while the G1-grid is at a fixed potential, or to the G1-grid only while the cathode is at a fixed potential. The amount of current flowing in the cathode is a representation of the intensity of the electron beam. Many ways are known to measure the current in the cathode, which is usually referred to as the beam current. Usually, the beam current measured is used to control the black level and/or the white level of the electron gun. Often, the control of the black level is referred to as automatic kinescope bias (AKB), or automatic black level control (ABL).

The gun may comprise further electrodes, such as for example, focusing electrodes or other electrodes to constitute, for example, a triode or a pentode together with the. first and the second electrode.

Usually, in color picture tubes, multiple (usually three) guns are present to generate multiple beam currents. The multiple beam currents may be measured to control the black and/or white level. The control of the black level is important to operate the gun at an optimal black level such that black information is displayed black independent of aging of the display apparatus. Further, the measurement of the black level makes it possible to obtain the correct ratio between low light levels of the different guns to provide uncolored display of gray display information. The measurement of the white level is used to control the correct ratio between the guns for the different colors at high light levels.

However, due to the capacitance between the cathode and the G1-grid, the measurement of the beam current at the cathode is disturbed. All changes in the drive signal will cause a capacitive current through this capacitance. The beam current measured at the cathode is the sum of the actual electron current and the capacitive current. This capacitive current may be relatively large as the voltage swing of the drive signal is relatively large. Consequently, the measured beam current is not a reliable representation of the electron current flowing in the electron gun. This is especially true when the beam current is measured during a display period in time when the video signal is displayed on the display screen and the drive signal continuously varies.

In conventional applications, the beam current is measured during the overscan periods. Here, one or more full lines are available during which a constant drive voltage of a predetermined level is supplied to the electron gun and the influence of the capacitance is minimal.

In applications wherein the beam current has to be measured during the display period, which for example is the case in tiled displays in which a total picture is built up out of segments which each have an associated electron gun, it is important that a brightness and/or contrast uniformity is maintained between all the tiles. As in this case the measurement of the beam current cannot be performed during the overscan periods, because at least some of the tiles may have no overscan area, the beam current has to be measured during the display period. In such applications, the desired brightness and/or contrast uniformity is not reached with the known beam current measurement.

The beam current measurement in accordance with the invention has an improved accuracy because the capacitive current is compensated for by supplying a compensation current to the first electrode which compensates the current flowing through the capacitance between the first electrode (usually the cathode) and the second electrode (usually the G1-grid). Consequently, the beam current measured will be disturbed less by the capacitive current.

In an embodiment as defined in claim 3, the compensation is obtained by supplying an inverse drive signal to a capacitor which is coupled to the first electrode. The amplitude of the inverse drive signal, which is the inverted drive signal supplied to the first and/or the second electrode, and the value of the capacitor have to be selected to obtain a compensating current which compensates the current through the capacitor between the first and the second electrode caused by the drive signal.

In an embodiment as defined in claim 4, a test signal generator generates a test signal during a test period. The test signal is the drive signal during the test period. A control circuit measures the beam current during the test period and electronically controls a value of the electronically adjustable capacitor to obtain a minimal measured beam current during the test period.

In an embodiment as defined in claim 5, the amplitude of the inverse drive signal is controlled to obtain a minimal measured beam current during the test period.

In the embodiments as defined in claim 4 or 5, it might be required to perform a series of measurements during a series of test periods to determine the optimal value of the capacitor or the amplitude of the inverse drive signal, respectively.

In an embodiment as defined in claim 6, the test periods are selected to occur during the line and/or frame flyback periods. The test signal should comprise a jump in its level to generate the capacitive currents through both the capacitance between the first and the second electrode and the compensation capacitor coupled to the first electrode. Preferably, the levels of the test signal are selected such that substantially no beam current will flow, and the testing is not visible to the user.

In an embodiment as defined in claim 7, the display apparatus comprises a plurality of electron guns which are arranged to direct the generated electron beams to substantially non-overlapping display areas. Such a display apparatus may comprise a tiled display. The tiled display is built up out of at least two substantially non-overlapping display areas. Each display area has an associated electron gun. For example, a separate cathode may be associated with each tile, or a wire cathode may be used which extends over at least two tiles. It is important that the brightness and contrast of each of the tiles is substantially equal to minimize the visibility of the tiles. Therefore, the measurement of the beam current of each of the tiles should be very accurate. The prior art measurement, without the capacitive current compensation, appeared to be too inaccurate and the tiles were visible.

In color displays, usually three electron guns are required. Now three separate cathodes or three separate wire cathodes may be present. In color displays it is further important to keep the color temperature of the tiles substantially equal. It might therefore be required to measure the beam current accurately at several drive signal levels.

In an embodiment as defined in claim 8, the electron gun is driven in a current feedback mode. The current feedback has the advantage that in all electron guns the same current will flow at the same input voltage, the drive voltages of the electron guns being automatically adapted to obtain the equal beam currents.

These and other aspects of the invention are apparent from and will be elucidated with reference to the embodiments described hereinafter.

In the drawings:

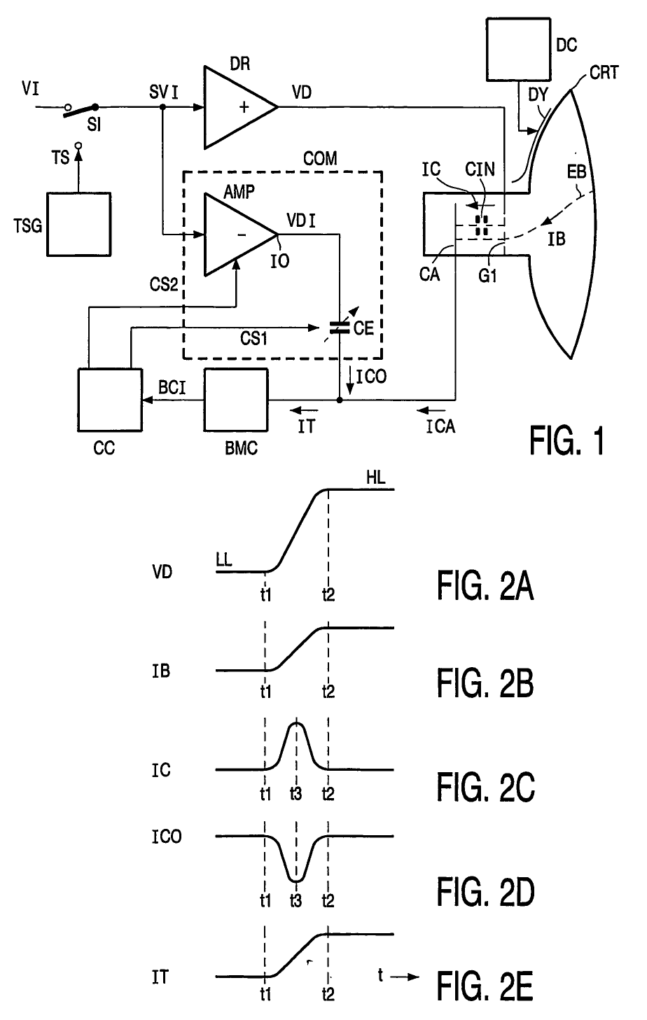

FIG. 1 shows a block diagram of a display apparatus with improved beam current sensing in accordance with an embodiment of the invention,

FIG. 2 show waveforms for elucidating the operation of the improved beam current sensing,

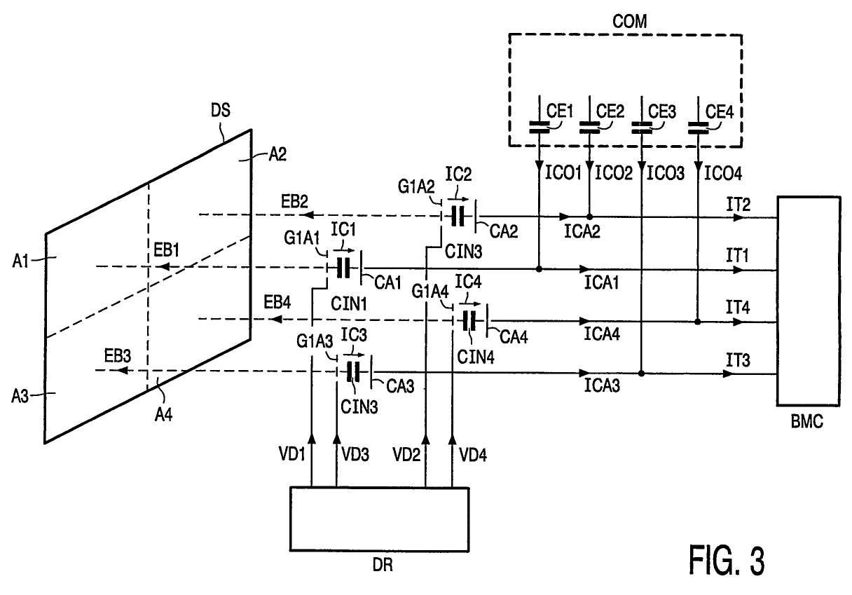

FIG. 3 shows a block diagram of a display apparatus with an improved beam current sensing in accordance with another embodiment of the invention,

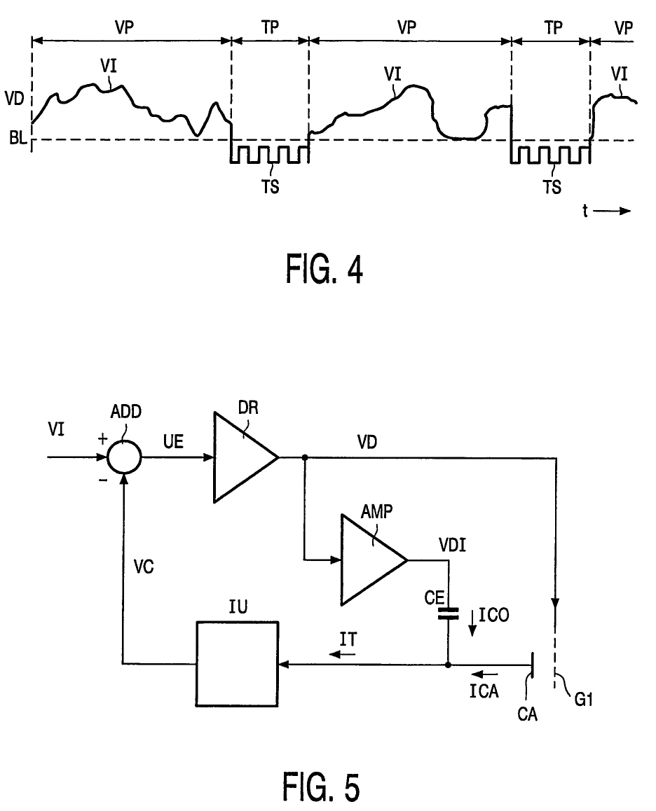

FIG. 4 shows a waveform of a drive signal with a test signal in accordance with an embodiment of the invention, and

FIG. 5 shows a block diagram of an embodiment of the display apparatus in accordance with the invention.

The same references in different FIGS. refer to the same signals or to the same elements performing the same function.

FIG. 1 shows a block diagram of a display apparatus with an improved beam current sensing in accordance with an embodiment of the invention.

By way of example, this embodiment of the invention shows a single cathode ray tube CRT with a single electron gun. The electron gun comprises the cathode CA as the first electrode and the G1-grid G1 as the second electrode. The electron gun may comprise further a heater to heat the cathode, and other grids. Due to the voltage difference across the cathode CA and the G1-grid G1, an electron beam EB will be generated. The electron beam EB is directed towards a screen of the cathode ray tube CRT by a high voltage present near the screen (not shown). The angle of deflection of the electron beam EB is determined by the magnetic field generated by a deflection yoke DY which is driven by a deflection circuit DC. Usually, the deflection yoke comprises (a) line and (a) frame deflection coil(s) for scanning the electron beam EB in frames (usually vertically scanned) or lines (usually horizontally scanned).

The electron beam EB substantially originates from the cathode CA causing a current called the beam current IB to flow in the cathode CA. However, due to the capacitance CIN between the cathode CA and the G1-grid, whenever the voltage between the cathode CA and the G1-grid changes, a current IC will flow through this capacitance CIN. Consequently, the total current ICA leaving the cathode CA is the sum of the beam current IB and the current IC through the capacitance CIN.

A driver circuit DR receives an input signal SVI and supplies a drive voltage VD to the G1-grid G1. The input signal SVI is selected by a switch S1 from an input video signal VI to be displayed on the screen of the cathode ray tube CRT and a test signal TS generated by a test generator TSG. The switch S1 and the test signal generator TSG are optional. A compensation circuit COM comprises an amplifier AMP and a capacitor CE. The amplifier AMP receives the input signal SVI and supplies a compensation signal VDI to one end of the capacitor CE. The other end of the capacitor CE is connected to the cathode CA. The compensation signal VDI has a polarity which is opposite to the polarity of the drive signal VD. An amplitude of the compensation signal VDI and a value of the capacitor CE are selected to obtain a compensation current ICO which compensates the current IC through the capacitance CIN. In the embodiment in accordance with the invention as shown in FIG. 1, the electron gun is driven by a voltage on the G1-grid only, the cathode is kept at a substantially constant potential.

More generally, the electron gun may also be driven by a varying voltage on both the cathode CA and the G1-grid, or on the cathode CA only. What counts for the intensity of the electron beam EB generated is the voltage difference between the cathode CA and the G1-grid G1. Thus more generally, the polarity and the amplitude of the compensation signal VDI, and the value of the capacitor CE have to be selected to compensate for the current IC through the capacitance CIN.

Although the compensation current ICO preferably is generated by supplying a voltage to a capacitor, other solutions are possible. For example, the compensation current may be generated by a current source directly. A waveform generator may be used to generate the current waveform required.

A beam current measurement circuit BMC is coupled to the junction of the cathode CA and the capacitor CE. The current IT measured by the beam current circuit BMC is the sum of the current ICA leaving the cathode CA and the compensation current ICO.

In an embodiment in accordance with the invention, the correct value of the capacitor CE is determined during a test period TP (see FIG. 4). During the test period TP, the test signal generator TSG generates a test signal. The switch S1, which outside the test period TP connects the input video signal VI to the drive circuit DR and the amplifier AMP, changes position to supply the test signal TS to both the drive circuit DR and the amplifier AMP. A control circuit CC which receives beam current information BCI from the beam current measurement circuit BMC controls the value of the capacitor CE with the control signal CS1. During the test period TP, at a particular value of the capacitor CE, the total current IT measured is evaluated. In the same or in a next test period TP the value of the capacitor CE is changed and again the total current IT is evaluated. The value of the capacitor CE is changed until the current IT measured indicates that the current IC through the capacitance CIN is compensated sufficiently accurately. The amplitude of the compensation signal VDI is kept constant.

Preferably, the capacitor CE is of a type of which the capacitance value changes with a value of a DC voltage across the capacitor CE. However, other possibilities exist to change the capacitance value, for example, several capacitors may be switchably connected in parallel. The actual value of the capacitor CE is determined by which capacitors are switched in parallel.

In another embodiment in accordance with the invention, the correct value of the amplitude of the compensation signal VDI is determined during a test period TP. During the test period TP, the test signal generator TSG generates a test signal TS. The switch S1, which outside the test period TP connects the input video signal VI to the drive circuit DR and the amplifier AMP, changes position to supply the test signal to both the drive circuit DR and the amplifier AMP. A control circuit CC which receives beam current information BCI from the beam current measurement circuit BMC controls the amplitude of the compensation signal VDI with the control signal CS2. During the test period TP, at a particular value of the amplitude of the compensation signal VDI, the total current IT measured is evaluated. In a next test period TP the value of the amplitude of the compensation signal VDI is changed and again the total current IT is evaluated. The amplitude of the compensation signal VDI is changed until the current IT measured indicates that the current IC through the capacitance CIN is compensated sufficiently accurately. The value of the capacitor CE is kept constant.

It is also possible to vary both the value of the capacitor CE and the amplitude of the compensation signal VDI.

Preferably, the test period TP occurs during the line and/or frame flyback periods. Preferably, if used, the test signal TS has levels which are below the cut-off level of the electron gun, such that the test signals are not visible. The test signal TS should have a transition to generate a current through both the capacitance CIN and the capacitor CE. Depending on the shape of the transition it can be concluded whether the compensation of the current IC through the capacitance CIN by the current ICO through the capacitor CE is sufficiently accurate.

The cathode ray tube CRT may comprise more than one electron gun. Usually, a color cathode ray tube CRT comprises three electron guns. Each one of the electron guns generates an electron beam EB which will land on the screen on the associated one of three phosphors emitting light in a primary color (Red, Green, Blue). Preferably, the compensation is performed on the cathodes of each one of the three electron guns.

FIGS. 2A-2E show waveforms for elucidating the operation of the improved beam current sensing.

FIG. 2A shows an example of the drive signal VD. The drive signal VD starts rising linearly at the instant t1 at a low level LL and reaches a high level HL at the instant t2.

FIG. 2B shows the beam current IB flowing in response to the drive signal VD. For the ease of explanation it is assumed that the relation between the drive signal VD and the beam current IB is linear.

FIG. 2C shows the current IC through the capacitance CIN between the cathode CA and the G1-grid G1. The current IC starts rising at the instant t1 because of the rising voltage VD. At the instant t3, the current IC through the capacitor CIN starts decreasing again until it is zero at the instant t2 at which the voltage VD reaches the high level HL.

FIG. 2D shows the compensation current ICO through the capacitor CE. This current ICO is opposite to the current IC to cancel the current IC. The compensation voltage VDI has a polarity opposite to that of the drive voltage VD, thus, from the instant t1 to the instant t2, the compensation voltage VDI changes from a high level to a low level. The amplitude of the compensation voltage VDI and the value of the capacitor CE are selected to obtain an as good a cancellation as possible.

It is possible to select the voltage VDI to be the drive voltage inverted in polarity. Thus, the voltage VDI has the same amplitude and varies within the same period of time in the same way. Then, the capacitor CE should have a value substantially equal to the value of the capacitance CIN. However, in this approach, the amplifier AMP has to generate the compensation voltage VDI with an amplitude as large as that of the voltage VD. This has the drawback that not only an expensive drive circuit DR able to generate high frequency high level signals, but also an expensive amplifier AMP is required. Therefore, preferably, the amplifier AMP generates a compensation voltage VDI with an amplitude smaller than the amplitude of the drive signal DV. The value of the capacitor CE has to be selected larger to compensate for the smaller amplitude. For example, the amplitude of the voltage VDI may be selected five times smaller than the amplitude of the drive voltage VD, and the capacitor CE has a value substantially five times the value of the capacitance CIN.

The amplifier AMP need not be a separate amplifier; it may be combined with the drive circuit DR. Usually, the drive circuit DR comprises an amplifier. This amplifier may comprise an inverter. The inverter may be coupled to the output of the amplifier of the drive circuit DR, or to a junction in the drive circuit at which a signal is available with lower amplitude than the output signal VD.

FIG. 2E shows the total current IT which is measured by the beam current measurement circuit BMC. The total current IT is substantially equal to the beam current IB because the current IC through the capacitance CIN is compensated for by the current ICO through the capacitor CE.

FIG. 3 shows a block diagram of a display apparatus with improved beam current sensing in accordance with another embodiment of the invention. The display apparatus comprises a tiled display area.

By way of example, the display area in FIG. 3 comprises four substantially non-overlapping sub areas or tiles A1 to A4. With each one of the tiles A1 to A4, an electron gun is associated. The electron guns each comprise a cathode CA1 to CA4, and a G1-grid G1A1 to G1A4, respectively. Capacitances CIN1 to CIN4 are present between the cathodes CA1 to CA4 and the G1-grids G1A1 to G1A4. The drive circuit DR supplies drive voltages VD1 to VD4 to the G1-grids G1A1 to G1A4, respectively. The cathodes CA1 to CA4 are kept on a substantially fixed potential. The compensation circuit COM is connected to the cathodes CA1 to CA4 via the capacitors CEI to CE4 to supply compensation currents ICO1 to ICO4, respectively. The beam current measurement circuit BMC is connected to the cathodes CA1 to CA4 to measure the total currents IT1 to IT4, respectively. The total currents IT1 to IT4 are the addition of the beam currents IB1 to IB4, the currents IC1 to IC4 through the capacitances CIN1 to CIN4, and the compensation currents ICO1 to IC04.

For each pair of associated cathodes CA1 to CA4 and G1-grids G1A1 to G1A4, respectively, the current through the capacitances CIN1 to CIN4 is compensated by the compensation currents ICO1 to ICO4, respectively.

Although, the cathodes CA1 to CA4 are shown as separate cathodes, they may be each part of a line cathode.

FIG. 4 shows a waveform of a drive signal with a test signal in accordance with an embodiment of the invention. The drive signal VD is shown for two successive full lines of a fame. Each line comprises an active video period VP during which the drive signal VD is the input video signal VI. The test periods TP, during which the drive signal VD is the test signal TS, occur during the line flyback periods in-between two successive active line periods VP.

FIG. 5 shows a block diagram of an embodiment of the display apparatus in accordance with the invention. In this embodiment in accordance with the invention, the electron gun is current-driven. The driver DR (which usually is a video output amplifier) receives the input signal UE and supplies the drive signal to the G1-grid of the electron gun. The cathode CA of the electron gun is kept at a substantially constant potential. The addition of the beam current and the capacitive current between the G1-grid and the cathode flows as the cathode current ICA through the cathode CA. The amplifier AMP supplies the correction voltage VDI to the capacitor CE to obtain a correction current ICO flowing towards the cathode CA. The current to voltage converter IU converts the total current IT to a voltage VC. The total current IT is the sum of the cathode current ICA and the correction current ICO, and thus resembles the real beam current very accurately.

The adder ADD subtracts the voltage VC from the input video voltage VI to supply the error voltage UE to the driver DR. In this current feedback system the driver DR will supply a drive voltage to the cathode or the G1-grid such that the total current IT (which is an accurate copy of the beam current) has a value such that the voltage VC is equal to the input video signal VI.

The current feedback is particular important when the invention is used in tiled displays wherein the picture comprises an array of electron guns. All these electron guns should produce the same brightness and contrast, otherwise the viewer will see the different tiles. However, the electron guns have different characteristics (for example, different gammas). This means that a same voltage will produce different beam currents in different electron guns. The current feedback has the advantage that in all electron guns the same current will flow at the same input voltage, the drive voltages of the electron guns are automatically adapted to obtain the equal beam currents. In such a beam current feedback system it is extremely important that the actual beam current is measured very accurately. The very accurate beam current is measured by using the compensation in accordance with the invention.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A display apparatus comprising
an electron gun comprising at least a first electrode (CA) and a second electrode (G1),
a drive circuit (DR) for supplying a drive signal (VD) to the first electrode (CA) and/or the second electrode (G1) to modulate an intensity of an electron beam (EB) originating from the first electrode (CA),
a beam current measurement circuit (BMC) coupled to the first electrode (CA) for measuring a measured beam current (IT) representing a beam current (IB) flowing in the first electrode (CA), and
a compensation circuit (COM) for supplying a compensation current (ICO) to the first electrode (CA) to compensate for a capacitive current (IC) through a capacitance (CIN) between the first electrode (CA) and the second electrode ( G1).

2. A display apparatus as claimed in claim 1, characterized in that the first electrode is a cathode (CA), and in that the second electrode is a G1-grid ( G1).

3. A display apparatus as claimed in claim 1, characterized in that the compensation circuit (COM) comprises
an amplifier (AMP) for supplying an inverted drive signal (VDI) being the drive signal (VD) inverted in amplitude at an amplifier output (IO) of the amplifier (AMP), and
a compensation capacitor (CE) coupled between the amplifier output (IO) and the first electrode (CA).

4. A display apparatus as claimed in claim 3, characterized in that the compensation capacitor (CE) is electronically adjustable, and in that the display apparatus further comprises a test signal generator (TSG) for generating a test signal (TS) during a test period (TP), and a control circuit (CC) for controlling a value of the compensation capacitor (CE) to obtain a minimal measured beam current (IT), measured during the test period (TP) in response to the test signal (TS).

5. A display apparatus as claimed in claim 3, characterized in that the amplifier (AMP) is adjustable, and in that the display apparatus further comprises a test signal generator (TSG) for generating a test signal (TS) during a test period (TP), and a control circuit (CC) for controlling the adjustable amplifier (AMP) to obtain a minimal measured beam current (IT), measured during the test period (TP) in response to the test signal (TS).

6. A display apparatus as claimed in claim 4 characterized in that the display apparatus further comprises a deflection circuit (DC) for deflecting the electron beam (EB) in frames of lines, wherein line flyback periods occur in-between the lines, and frame flyback periods occur in-between successive frames, the test period (TP) occurring during the frame and/or the line flyback periods.

7. A display apparatus as claimed in claim 1, characterized in that the display apparatus comprises
a plurality of electron guns for generating a plurality of electron beams (EB1, EB2, EB3, EB4), the plurality of electron guns being arranged to direct the plurality of electron beams (EB1, EB2, EB3, EB4) to substantially non-overlapping display areas (A1, A2, A3, A4),
the drive circuit (DR) being adapted for supplying a plurality of drive signals (VD1, VD2, VD3, VD4) to first electrodes (CA1, CA2, CA3, CA4) and/or second electrodes (G1A1, G1A2, G1A3, G1A4) of the plurality of electron guns so as to modulate an intensity of the plurality of electron beams (EB1, EB2, EB3, EB4),
the beam current measurement circuit (BMC) being adapted for measuring measured beam currents (IT1, IT2, IT3, IT4) flowing in the first electrodes (CA1, CA2, CA3, CA4) in response to the plurality of electron beams (EB1, EB2, EB3, EB4), and
the compensation circuit (COM) being adapted for supplying a plurality of compensation currents (ICO1, ICO2, ICO3, ICO4), each one of the plurality of compensation currents (ICO1, ICO2, ICO3, ICO4) being supplied to an associated one of the first electrodes (CA1, CA2, CA3, CA4) to compensate for the capacitive current (IC1, IC2, IC3, IC4) through the capacitance (CIN1, CIN2, CIN3, CIN4) between the associated one of the first electrodes (CA1, CA2, CA3, CA4) and its associated second electrode (G1A1, G1A2, G1A3, G1A4).

8. A display apparatus as claimed in claim 1, characterized in that the drive circuit (DR) comprises
a current to voltage converter (IU) for converting the measured beam current (IT) into a measured voltage (VC), and
a subtractor (ADD) for subtracting the measured voltage (VC) from an input signal (VI) to supply an error voltage (UE) to the drive circuit (DR) to obtain the drive signal (VD).

9. A beam current measurement circuit as claimed in claim 1.

10. A method of measuring a beam current in a display apparatus comprising an electron gun comprising at least a first electrode (CA) and a second electrode (G1), the method comprising
supplying (DR) a drive signal (VD) to the first electrode (CA) and/or the second electrode (G1) to modulate an intensity of an electron beam (EB) originating from the first electrode (CA),
measuring (BMC) a measured beam current (IT) representing a beam current (IB) flowing in the first electrode (CA), and
supplying (COM) a compensation current (ICO) to the first electrode (CA) to compensate for a capacitive current (IC) through a capacitance (CIN) between the first electrode (CA) and the second electrode (G1).
